(19) United States
(12) Patent Application Publication
(10) Pub. No.: US 2003/0125037 A1
(43) Pub. Date: Jul. 3, 2003

(54) Method of controlling reverse data transmission in a mobile communication system

(75) Inventors: Beom-Sik Bae, Suwon-shi (KR); Dong-Ho Cho, Seoul (KR); Young-Wook Jung, Taejon-Kwangyokshi (KR); Jung-Woo Cho, Koje-shi (KR); Tae-Soo Kwon, Taejon-Kwangyokshi (KR); Jung-Su Jung, Seoul (KR); Chang-Hoi Koo, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., Kyungki-do (KR)

(21) Appl. No.: 10/331,814

(22) Filed: Dec. 30, 2002

(30) Foreign Application Priority Data
Dec. 29, 2001 (KR) 2001-88393

(51) Int. Cl. H04Q 7/20

(52) U.S. Cl. 455/450; 455/466

(57) ABSTRACT

A method of controlling reverse data transmission in a mobile communication system is disclosed. At a reverse data channel setup, an MS and a BS negotiate a reverse data rate and a transmission duration. After the reverse data channel is established, whether to permit reverse data transmission or not is determined periodically. Therefore, overhead in the MS and the BS is reduced and reverse transmission throughput is increased. The MS reports the amount of transmission data and its forward channel state to the BS periodically or non-periodically. Based on the information, the BS then controls reverse data rates individually. During data transmission, if the BS determines to change a data rate, it notifies a corresponding MS of the changed data rate. Thus, reverse data transmission is controlled adaptively according to a variable channel environment.

### PRIORITY

This application claims priority to an application entitled “Method of Controlling Reverse Data Transmission in a Mobile Communication System” filed in the Korean Industrial Property Office on Dec. 29, 2001 and assigned Serial No. 2001-88393, the contents of which are incorporated herein by reference.

### BACKGROUND OF THE INVENTION

1. Field of the Invention

The present invention relates generally to a mobile communication system, and in particular, to a method of controlling data transmission on a reverse link directed from a mobile station (MS) to a base station (BS).

2. Description of the Related Art

A CDMA2000 (Code Division Multiple Access 2000) 1× system and its improved model, a CDMA2000 1×EV-DO (EVolution-Data Only) system each include MSs and BSs. Mobile communication technology has been developed from providing only voice service to additionally providing pictures and high-rate data service over the Internet. In this context, a 1×EV-DV (EVolution-Data and Voice) system supporting both voice and data services is currently being standardized. In the 1×EV-DV system, a BS separately deals with a circuit channel for voice service and a packet channel for data service, assigning the data service the remaining radio resources except for radio resources assigned to the voice service. The radio resources refer to power, Walsh codes, and time slots.

The mobile communication system supporting data service aims at efficient high-rate packet transmission. To efficiently transmit data on a forward link and a reverse link, radio resources must be scheduled appropriately in time division. In forward data transmission, a BS transmits data only to an MS in the best channel state by checking the air states of a plurality of MSs connected to the BS and other propagation environments, thereby maximizing transmission throughput. In reverse data transmission, the MSs access the BS simultaneously. Therefore, the BS needs to control overload through control of data congestion and data received from the MSs.

Data Transmission in CDMA2000 1× System

In the CDMA2000 1× system, one or more reverse supplemental channels (R-SCHs) are assigned for high-rate reverse data transmission. The R-SCHs are assigned at a call setup or during a call, and released shortly after their use is terminated. For assignment of an R-SCH, an MS transmits to a BS a signaling assignment request message requesting the R-SCH. The signaling assignment request message contains information about the buffer state of the MS. If an R-SCH is available, the BS transmits to the MS a signaling assignment message. The signaling assignment message contains information about an allowed data size, an allowed transmission duration, and a channel configuration assigned to the R-SCH. After transmitting a response for the signaling assignment message to the BS, the MS transmits reverse data at the allowed data rate on the assigned R-SCH during the transmission duration.

In the above reverse data transmission, however, since the BS and the MS exchange signaling messages each time the MS transmits burst data, a great deal of time is required to start the reverse data transmission. Moreover, relatively long signaling messages are exchanged even when the MS transmits short burst data, thereby increasing control traffic. In order to change the data rate or discontinue the reverse data transmission after the reverse channel is assigned with the allowed data rate, new signaling messages are exchanged between the MS and the BS. As a result, time delay is involved with a data rate change. The resulting difficulty in adapting to a channel environment that varies moment to moment decreases the capacity of the reverse link. A method has been proposed to solve this problem in the CDMA2000 1×EV-DO system.

Data Transmission in CDMA2000 1×EV-DO system In the 1×EV-DO system, reverse data transmission is carried out according to an RAB (Reverse Activity Bit) and a ReverseRateLimit (RRL) message received from a BS. An MS reports its variable reverse data rate to the BS with an RRI (Reverse Rate Indicator). The RRL message is a signaling message that limits the reverse data rate. That is, the reverse data rate is set not to exceed a maximum rate indicated by the RRL message. The RAB is transmitted to all MSs connected through the BS, indicating a congestion degree of the reverse link. According to the RAB, the MSs control reverse data rates. That is, the MSs increase, decrease, or maintain their current data rates according to the RAB. The BS controls the overload and capacity of the reverse link by using the RAB.

Since the RAB is broadcast, all MSs within the coverage area of the BS control their data rates indiscriminately according to the RAB. If the RAB indicates “UP”, the MSs increase or maintain their data rates, and if the RAB indicates “DOWN”, the MSs decrease or maintain their data rates. Since the MSs use random numbers generated according to the RAB in controlling the data rates, the reverse data rates are changed not consistently but with probability. Therefore, it is impossible for the BS to efficiently estimate reverse channel states and control the data rates. As a result, overload and underload may alternate on the reverse link, decreasing the capacity of the reverse link.

### SUMMARY OF THE INVENTION

It is, therefore, an object of the present invention to provide a method of efficiently controlling reverse packet data transmission in order to increase reverse transmission throughput in a mobile communication system.

It is another object of the present invention to provide a method of conducting negotiations on reverse data rates between a BS and MSs when channels are set up for reverse data transmission.

It is a further object of the present invention to provide a method of determining whether to permit transmission of reverse packet data on a frame basis at reverse data rates that are negotiated between a BS and MSs when the BS assigns channels to the MSs.

It is still another object of the present invention to provide a method of controlling reverse data rates individually in a BS if MSs periodically inform the BS of their transmission states, with reverse data channels connected.

To achieve the above and other objects, in a method of controlling reverse data transmission to a BS in a mobile communication system supporting a reverse data service, an MS negotiates a reverse data rate and a transmission duration with the BS, upon generation of reverse data, and connects a reverse data channel to the BS. The MS receives a permission information by periodically monitoring a F-APCCH (Forward Access Permission Control CHannel). Here, the permission information indicates whether reverse data transmission is permitted. If the permission information indicates permission of the reverse data transmission, the MS transmits the reverse data to the BS at the data rate on the reverse data channel during the transmission duration.

In a method of controlling reverse data transmission from an MS in a mobile communication system supporting reverse data service, upon request of reverse data transmission from the MS, a BS negotiates a reverse data rate and a transmission duration with the MS and connects a reverse data channel to the MS. The BS periodically determines permission information for the MS. Here, the permission information indicates whether reverse data transmission is permitted. The BS transmits the permission information to the MS on a forward access permission control channel.

### BRIEF DESCRIPTION OF THE DRAWINGS

The above and other objects, features, and advantages of the present invention will become more apparent from the following detailed description when taken in conjunction with the accompanying drawings in which:

FIG. 1 is a flowchart illustrating an operation in an MS for negotiating a reverse data rate and a transmission duration with a BS in accordance with an embodiment of the present invention;

FIG. 2 is a flowchart illustrating an operation in the BS for negotiating with the MS on the reverse data rate and the transmission duration in accordance with the embodiment of the present invention;

FIG. 3 is a flowchart illustrating a control operation for supporting reverse data transmission in the BS in accordance with the embodiment of the present invention;

FIG. 4 is a flowchart illustrating a reverse data transmission operation in the MS in accordance with the embodiment of the present invention;

FIG. 5 is a flowchart illustrating a signaling message transmission operation for supporting reverse data transmission in the BS in accordance with the embodiment of the present invention;

FIG. 6 is a flowchart illustrating a signaling message reception operation for the reverse data transmission in the MS in accordance with the embodiment of the present invention;

FIG. 7 is a flowchart illustrating a buffer size reporting operation in the MS in accordance with the embodiment of the present invention;

FIG. 8 is a flowchart illustrating a channel state reporting operation in the MS in accordance with the embodiment of the present invention;

FIG. 9 is a flowchart illustrating an operation for reporting a buffer size and a channel state in the MS as its active set is changed in accordance with the embodiment of the present invention; and

FIG. 10 is a flowchart illustrating a signaling message reception operation for supporting the reverse data transmission in the BS in accordance with the embodiment of the present invention.

### DETAILED DESCRIPTION OF THE PREFERRED EMBODIMENT

An embodiment of the present invention will be described herein below with reference to the accompanying drawings. In the following description, well-known functions or constructions are not described in detail since they would obscure the invention in unnecessary detail.

The present invention pertains to controlling reverse data rates in a 1×EV-DV system. In connection with the reverse data rate control, operations of an MS and a BS and a physical layer structure will be described. In accordance with the present invention, a reverse data rate is negotiated when a reverse data channel is set up and after the channel setup, it is determined whether reverse data transmission is permitted. With channels established, MSs report channel states to a BS and the BS controls data transmission individually according to MSs' states. When a reverse data rate is to be changed, the MS or the BS changes the reverse data rate using a signaling message. Here, a reverse data rate represents an amount of transmission data.

The reverse data rate control in accordance with the present invention will be described below under the sub-headings: channel structure; reverse data channel connection; reverse data rate control; and reverse channel release.

b 1. Channel Structure

Besides a channel for transmitting a signaling message and an R-SCH for transmitting reverse data, a BS further assigns a forward access permission control channel (F-APCCH) to deliver a permission bit indicating whether reverse data transmission is permitted in each frame of the R-SCH. For example, if the permission bit is 0, it indicates “wait” and if it is 1, it indicates “transmit”.

The F-APCCH is comprised of a predetermined number of, for example, 16 sub-channels (i.e. sub-slots). An R-SCH and an F-APCCH sub-slot are simultaneously assigned to an MS so that a BS can provide dedicated control to the MS. The F-APCCH can be formed in the same structure as a forward common power control channel (F-CPCCH) provided by IS-2000(International Standard)

2. Reverse Data Channel Connection

The MS sets up an R-SCH for reverse data transmission. In view of the burst character of a data service, a transmission period and a non-transmission period may alternate irregularly in a data channel. Thus the MS and the BS hold in a dormant state during the non-transmission period, and transition to an active state upon generation of transmission data. In the active state, the MS requests assignment of an R-SCH and negotiates a reverse data rate and a transmission duration with the BS. The data rate and transmission duration are collectively referred to as control information about reverse data.

The MS uses an RSCRM (Reverse Supplemental Channel Request Message) as illustrated in Table 1 when requesting the R-SCH and the BS uses an RSCAM (Reverse Supplemental Channel Assignment Message) as illustrated in Table 2 in response to the RSCRM to assign the R-SCH and indicate a permitted data rate and a permitted transmission duration.

TABLE 1

| Field | Length (bits) |
|---|---|
| SIZE_OF_BUF_BLOB | 4 |
| REQ_BUF | 8 |
| REF_PN | 0 or 9 |
| PILOT_STRENGTH | 0 or 6 |
| NUM_ACT_PN | 0 or 3 |
| If NUM_ACT_PN is included, the MS shall include | |
| NUM_ACT_PN occurrences of the following record: | |
| ACT_PN_PHASE | 15 |
| ACT_PILOT_STRENGTH | 6 |
| NUM_NGHBR_PN | 0 or 3 |
| If NUM_NGHBR_PN is included, the MS shall include | |
| NUM_NGHBR_PN occurrences of the following record: | |
| NGHBR_PN_PHASE | 15 |
| NGHBR_PILOT_STRENGTH | 6 |

The information fields of the RSCRM listed in Table 1 have the following meanings as R-SCH assignment information.

SIZE_OF_BUF_BLOB: a unit of buffer size in the MS;

REQ_BUF: the current buffer size in the MS;

REF_PN: time reference PN sequence offset;

PILOT_STRENGTH: reference pilot strength;

NUM_ACT_PN: the number of PN sequence offsets in an active set;

ACT PN_PHASE: the measured PN sequence offset of an active pilot;

ACT_PILOT_STRENGTH: active pilot strength;

NUM_NGHBR_PN: the number of PN sequence offsets in a candidate set and a neighbor set;

NGHBR_PN_PHASE: the PN offset of a neighbor pilot; and

NGHBR_PILOT_STRENGTH: neighbor pilot strength.

The RSCRM includes at least information about the buffer size of the MS so that the BS determines a data rate and a transmission duration. The buffer size indicates the amount of current data stored in a transmission buffer of the MS. That is, the buffer size is the amount of transmission data. The RSCRM is transmitted on a dedicated or common control channel and has a time span of 20 ms like a typical message or 5 ms like a mini message. If the RSCRM is transmitted on the common control channel, it further includes the ID of the MS so that the BS identifies the MS.

TABLE 2

| Field | Length (bits) |
|---|---|
| REV_SCH_DTX_DURATION | 4 |
| REV_SCH_NUM_BITS_IDX | 4 |
| APCCH_INCL | 1 |
| APCCH_ID | 0 or 2 |
| APCSCH_ID | 0 or 4 |

The information fields of the RSCAM listed in Table 2 have the following meanings.

REV_SCH_DTX_DURATION: transmission duration of reverse data;

REV_SCH_NUM_BITS_IDX: index indicating the amount of data during the transmission duration;

APCCH_INCL: information indicating whether F-APCCH assignment information is included or not;

APCCH_ID: the ID of an assigned F-APCCH; and

APCSCH_ID: the position of an assigned sub-slot in the F-APCCH.

The reverse data rate of the MS is determined according to REV_SCH_DTX_DURATION and REV_SCH_NUM_BITS_IDX. The RSCAM may include APCCH_ID and APCSCH_ID depending on the value of APCCH_INCL. In Table 2, APCCH_ID is 2 bits and APCSCH_ID is 4 bits, which implies that reverse data transmission from MSs is controlled using 4 F-APCCHs and 16 F-APCCH sub-slots. The numbers of bits assigned to the two fields can be set freely.

While the F-APCCH assignment information is delivered by the RSCAM in an embodiment of the present invention, it can be further contemplated as another embodiment that the F-APCCH assignment information is included in another message transmitted on a control channel. In this case, the message is configured to further include the two fields, APCCH_ID and APCSCH_ID, or a novel message including the fields is defined.

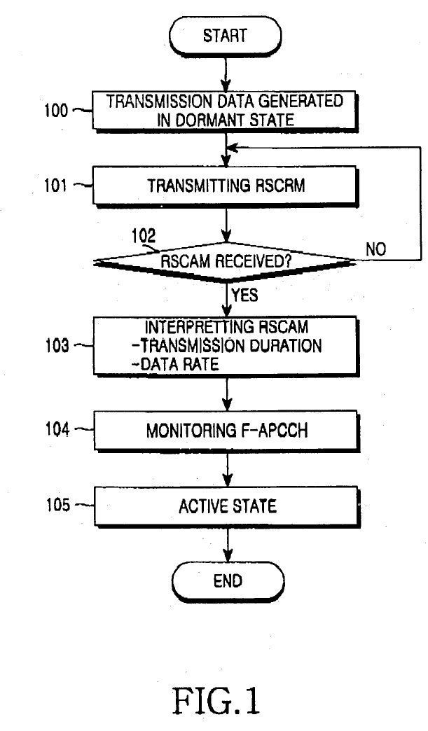

FIG. 1 is a flowchart illustrating an operation in an MS for negotiating a reverse data rate and a transmission duration with a BS in accordance with an embodiment of the present invention. Referring to FIG. 1, upon generation of transmission data in a dormant state in step 100, the MS transmits an RSCRM to the BS in step 101. As described above, the RSCRM informs the BS that reverse data transmission will occur and requests assignment of an R-SCH to the BS. The MS then awaits reception of an RSCAM from the BS. Upon receipt of the RSCAM from the BS in step 102, the MS detects a data rate and a transmission duration set from REV_SCH DTX_DURATION and REV_SCH_NUM_BITS_IDX in the RSCAM in step 103, and starts to monitor an F-APCCH assigned to the MS in step 104. According to a permission bit included in the F-APCCH, the MS transmits data on the R-SCH in an allowed frame and waits in a non-allowed frame in step 105. In the former case, the MS transmits reverse data at the determined data rate during the determined transmission duration.

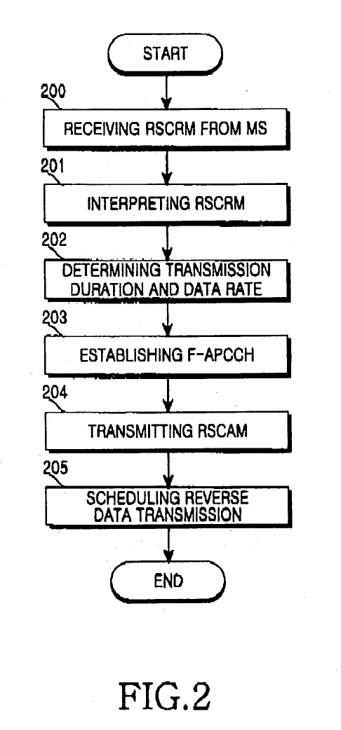

FIG. 2 is a flowchart illustrating an operation in the BS for negotiating a reverse data rate and a transmission duration with the MS according to the embodiment of the present invention. Referring to FIG. 2, upon receipt of the RSCRM from the MS in step 200, the BS interprets the information fields of the RSCRM, considering that the MS is to transmit reverse data on an R-SCH in step 201. According to the information fields, service options set at a call setup for the MS, and other information received from the MS, the BS determines a transmission duration and a reverse data rate for the MS in step 202. In addition, the BS establishes an F-APCCH and selects a sub-slot of the F-APCCH for the MS in step 203 and transmits to the MS the RSCAM representing the determined transmission duration and reverse data rate in step 204. Then the BS schedules reverse data transmission for MSs including the MS, to which reverse data channels are assigned, sets permission bit values, and delivers the F-APCCH having the permission bits to the MSs in step 205. In this manner, the reverse data transmission is controlled.

3. Reverse Data Rate Control

After the R-SCH is assigned to the MS in the above-described reverse data channel connection procedure, the MS continuously transmits as much data as determined according to the determined data rate during the determined transmission duration each time reverse data transmission is permitted. The reverse data rate of the MS is determined according to the determined data rate and transmission duration. Alternatively, the MS can set its data rate explicitly in a message delivered to the BS.

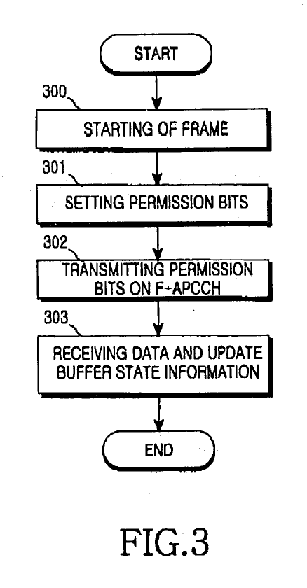

FIG. 3 is a flowchart illustrating a control operation for supporting reverse data transmission in the BS according to the embodiment of the present invention. Referring to FIG. 3, when each frame starts, or each time a predetermined reference frame starts in step 300, the BS schedules reverse data transmission according to buffer sizes (i.e., transmission data amounts), the amounts of already transmitted data, and channel states which are reported from MSs in an active state, and sets permission bits for the MSs in step 301.

As an embodiment of the scheduling, a known Proportional-Fair Scheduling algorithm can be used. In the algorithm, the MSs are prioritized in an order of large buffer size, small data amount, and high data rate, and data transmission is permitted first to a higher-priority MS. The BS then sets permission bits to “transmit” for MSs having higher priority levels or transmission data equal to or less than a reception buffer size of the BS. The BS sets permission bits to “wait” for the other MSs.

The permission bits are delivered to the MSs in their respective sub-slots of an assigned F-APCCH in step 302. At the same time, the BS receives data from the MSs on R-SCHs and updates information about the amount of data transmitted by the MSs with the amount of the received data in step 303. The updated information is used for scheduling for the next reference frame.

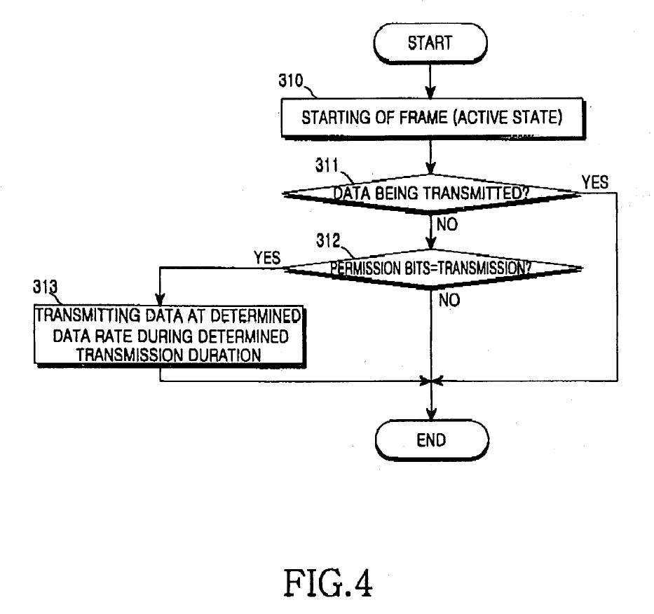

FIG. 4 is a flowchart illustrating reverse data transmission in an MS according to the embodiment of the present invention. Referring to FIG. 4, each time a frame starts after an R-SCH is established in step 310, the MS determines whether data is transmitted in the current frame in step 311. If a permission bit is received in each frame, step 311 is omitted. On the other hand, if the permission bit is received every two or four frames, step 311 is performed because the permission bit need not be checked during data transmission in the current frame. If data is not transmitted in the current frame, the MS checks a permission bit in a previous F-APCCH frame or permission bits monitored during data transmission in step 312. If the former permission bit indicates “transmit”, or the latter permission bits all indicate “transmit”, the MS transmits data during a transmission duration on the assigned R-SCH in step 313. The amount of the data and the transmission duration are set in an RSCAM received from the BS at the R-SCH setup. If the permission bit or permission bits indicate “wait”, the MS does not transmit data.

At a soft handoff where the MS is simultaneously connected to at least two BSs in its active set, the MS can receive a permission bit from each of the BSs. In this case, the MS operates in one of the following ways.

(1) The BSs transmit the same permission bit to the MS at a certain time, and the MS operates according to the permission bit. To do so, a handoff controller controls the value of the permission bit for the BSs.

(2) After a primary active set is defined from the active set, the MS operates according to a permission bit received from at least one BS in the primary active set. The primary active set includes a predetermined number of BSs having relatively strong pilots in the active set.

(3) The MS combines permission bits received from the BSs in a predetermined method (AND/OR/MAX) and determines whether to transmit data according to the combination result. In the case of AND gating, the reverse data is transmitted if both permission bits indicate “transmit”. In the case of OR gating, the reverse data is transmitted if either of the permission bits indicates “transmit”. In the case of MAX operation, it is determined whether to transmit the reverse data according to a permission bit from a BS having the stronger pilot.

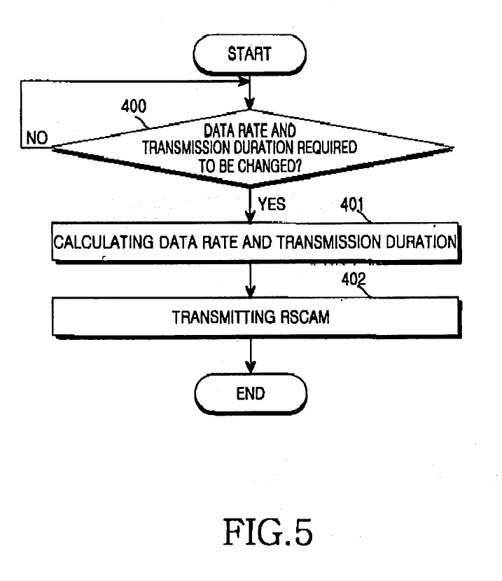

FIG. 5 is a flowchart illustrating a signaling message transmitting operation for supporting reverse data transmission in the BS according to the embodiment of the present invention. Referring to FIG. 5, when the buffer size and channel state of the MS in the active state, and the reverse link load are changed, the BS determines that the data rate and the transmission duration for the MS are to be changed in step 400. The BS then calculates a transmission duration and a data rate for the MS using the changed information in step 401 and transmits to the MS an RSCAM representing the calculated transmission duration and data rate in step 402. That is, when the BS determines to increase the reverse transmission throughput under any circumstances, it transmits the RSCAM non-periodically.

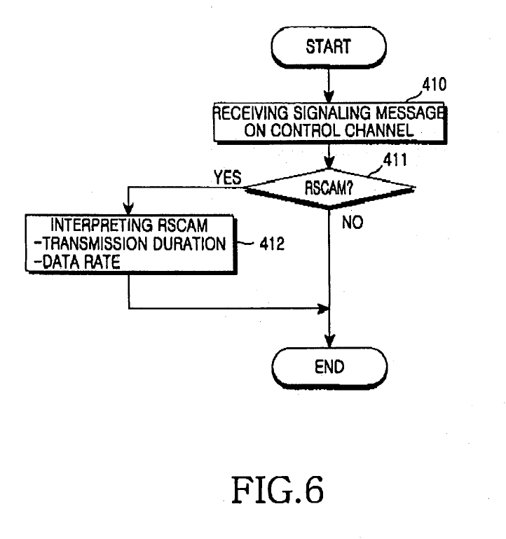

FIG. 6 is a flowchart illustrating a signaling message receiving operation for reverse data transmission in the MS according to the embodiment of the present invention. Referring to FIG. 6, when a signaling message has been received from the BS on a control channel in step 410 and the received message is an RSCAM in step 411, the MS updates its transmission duration and data rate by analyzing the information fields of the RSCAM in step 412. The updated transmission duration and data rate are applied to data transmission in the next frame.

As described above, the MS transmits reverse data at a data rate during a transmission duration, the data rate and the transmission duration being set by the BS at an R-SCH setup. Then, if the MS receives the transmission duration and the data rate changed from the BS, the MS transmits reverse data at the changed data rate during the changed transmission duration. For the BS to continuously control the transmission durations and data rates of all MSs, the MSs continuously report their data transmission states to the BS. The data transmission state information is used for scheduling and includes information about the buffer sizes and channel states of the MSs and the amount of data transmitted from the MSs. Since the amount of transmitted data is known by the amount of data received in the BS, the BS receives only information about the buffer sizes and the channel states.

To transmit its data transmission state information, an MS uses an MBSM (Mobile Buffer Status Message) for reporting its buffer size and an RSCSM (Reverse Supplemental Channel Status Message) for reporting its channel state.

The MBSM is formatted as illustrated in Table 3 below.

TABLE 3

| Field | Length (bits) |
|---|---|
| REQ_BUF | 8 |

Referring to Table 3, the MBSM includes at least REQ_BUF indicating the current buffer size of the MS. As stated before, the buffer size is the amount of data stored in the transmission buffer of the MS, that is, the amount of transmission data. If the buffer state of the MS is changed due to generation of new burst data in the active state, the MS reports the changed buffer size to the BS by the MBSM.

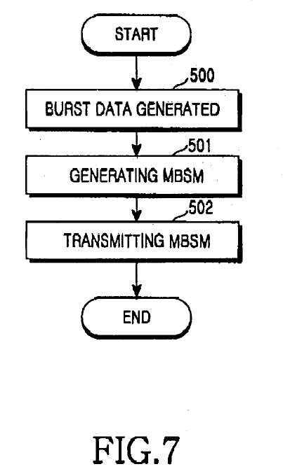

FIG. 7 is a flowchart illustrating a buffer size reporting operation in the MS according to the embodiment of the present invention. Referring to FIG. 7, upon generation of new burst data in an active state in step 500, the MS generates an MBSM in step 501, and transmits to the BS the MBSM including information about the current buffer size in step 502. The MBSM is delivered to the BS on a common control channel with other signaling messages, or on a dedicated control channel.

The RSCSM is formatted as illustrated in Table 4.

TABLE 4

| Field | Length (bits) |
|---|---|
| REF_PN | 0 or 9 |
| PILOT_STRENGTH | 0 or 6 |
| NUM_ACT_PN | 0 or 3 |
| If NUM_ACT_PN is included, the MS shall include | |
| NUM_ACT_PN occurrences of the following record: | |
| ACT_PN_PHASE | 15 |
| ACT_PILOT_STRENGTH | 6 |
| NUM_NGHBR_PN | 0 or 3 |
| If NUM_NGHBR_PN is included, the MS shall include | |
| NUM_NGHBR_PN occurrences of the following record: | |
| NGHBR_PN_PHASE | 15 |
| NGHBR_PILOT_STRENGTH | 6 |

The information fields of the RSCSM in Table 4 have the following meanings.

REF_PN: time reference PN sequence offset;

PILOT_STRENGTH: reference pilot strength;

NUM_ACT_PN: the number of PN sequence offsets in an active set;

ACT_PN_PHASE: the measured PN sequence offset of an active pilot;

ACT_PILOT_STRENGTH: active pilot strength;

NUM_NGHBR_PN: the number of PN sequence offsets in a candidate set and a neighbor set;

NGHBR_PN_PHASE: the PN offset of a neighbor pilot; and

NGHBR_PILOT_STRENGTH: neighbor pilot strength.

In another embodiment of the present invention, the RSCSM can be configured to have part of the fields listed in Table 4.

Upon sensing a rapid change in the air channel in an active state, the MS transmits an RSCSM representing its current channel state to the BS.

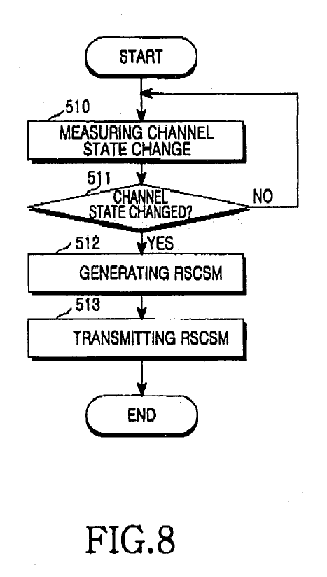

FIG. 8 is a flowchart illustrating a channel state reporting operation in the MS according to the embodiment of the present invention. Referring to FIG. 8, the MS measures a channel state change in step 510. Upon sensing a change in the channel state in step 511, the MS generates an RSCSM in step 512, and transmits to the BS the RSCSM representing the changed channel state in step 513. The channel state is represented by the PN sequence offset and signal strength (e.g., carrier to interference ratio) of a received pilot. The RSCSM is transmitted to the BS on a common control channel with other signaling messages, or on a dedicated channel.

Meanwhile, if its active set is changed as the MS moves, the MS transmits an MBSM and an RSCSM to all BSs in its changed active set in order to notify new BSs added to the active set of its buffer size and channel state.

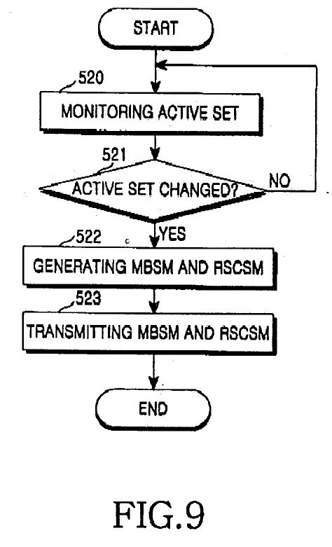

FIG. 9 is a flowchart illustrating an operation for reporting a buffer size and a channel state in the MS when its active set is changed as it moves according to the embodiment of the present invention. Referring to FIG. 9, the MS monitors the active set in step 520. When its active set is changed as the MS moves in step 521, the MS generates an MBSM and an RSCSM in step 522, and transmits to BSs in the changed active set the MBSM representing the current buffer size and the RSCSM representing the current channel state in step 523. It is preferable that the MS transmits the MBSM and the RSCSM only when a new BS is added to its active set.

Upon receipt of the MBSM or the RSCSM from the MS in the active state, each of the BSs updates information about the buffer size and channel state for the MS and schedules reverse data transmission based on the updated information.

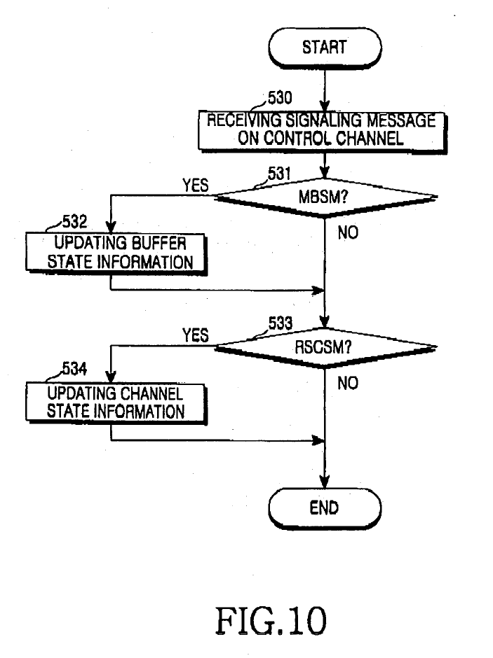

FIG. 10 is a flowchart illustrating a signaling message receiving operation for supporting reverse data transmission in the BS according to the embodiment of the present invention. Referring to FIG. 10, if a signaling message is received from an MS on a control channel in step 530 and the received message is an MBSM in step 531, the BS detects the buffer size of the MS by analyzing the MBSM, updates information about the buffer size, and uses the updated information for scheduling for the next period in step 532. If the received message is an RSCSM in step 533, the BS detects the channel state of the MS by analyzing the RSCSM, updates information about the channel state, and uses the updated information for scheduling for the next period in step 534.

The above reverse data rate control procedures in the MS and the BS are continuously performed as long as the MS is in the active state.

4. Reverse Channel Release

If the transmission buffer of the MS is empty after all data is transmitted, the MS transmits to the BS an RCRM (Reverse Channel Release Message) requesting release of an assigned R-SCH, releases the R-SCH, and transitions to a dormant state according to an active timer. The RCRM includes the ID of the R-SCH. Upon receipt of the RCRM, the BS sets data transmission information about the MS (buffer size, channel state, etc.) to initial values and releases the R-SCH and F-APCCH.

In accordance with the present invention, instead of directly controlling a reverse data rate, a BS and an MS set the reverse data rate at a channel setup. During data transmission, it is only determined whether to permit reverse data transmission on a frame basis. Therefore, reverse link resources can be efficiently utilized according to channel states without increasing overhead. As a result, system performance and system capacity are ensured. Furthermore, individual reverse data rates are efficiently controlled, taking the channel states of MSs into account.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of controlling in a mobile station (MS) reverse data transmission to a base station (BS) in a mobile communication system supporting a reverse data service, comprising the steps of:
upon generation of reverse data, setting a reverse data rate, and a transmission duration negotiated with the BS, and connecting a reverse data channel to the BS;
receiving a permission information by periodically monitoring a forward access permission control channel, the permission information indicating whether reverse data transmission is permitted; and
transmitting the reverse data to the BS at the data rate on the reverse data channel during the transmission duration, if the permission information indicates permission of the reverse data transmission.

2. The method of claim 1, wherein the reverse data channel connecting step comprises the steps of:
upon generation of the reverse data in a dormant state, transmitting to the BS an assignment request message including assignment information about the reverse data channel; and
receiving from the BS an assignment message including information about the reverse data rate and the transmission duration in response to the assignment request message.

3. The method of claim 1, wherein the permission information is transmitted in each frame of the forward access permission control channel.

4. The method of claim 1, further comprising the steps of:
receiving from the BS information about a changed data rate and a changed transmission duration after the reverse data channel is connected; and
changing the data rate and the transmission duration according to the received information.

5. The method of claim 1, further comprising the step of, if the amount of transmission data from the MS is changed due to a generation of new reverse data after the reverse data channel is connected, reporting the changed amount of the transmission data to the BS.

6. The method of claim 1, further comprising the step of, if a channel state of the MS is changed, reporting the changed channel state to the BS.

7. The method of claim 1, further comprising the step, if the MS is connected to a new BS by a new reverse data channel, reporting the amount of current transmission data and a current channel state of the MS to the new BS.

8. The method of claim 1 further comprising the steps of:
receiving the permission information from all BSs connected to the MS by periodically monitoring forward access permission control channels; and
transmitting the reverse data to the BSs according to a data rate and a transmission duration negotiated with at least one of the BSs, if a combination of the permission information indicates transmission permission.

9. A method of controlling in a base station (BS) reverse data transmission from a mobile station (MS) in a mobile communication system supporting reverse data service, comprising the steps of:
upon a request for reverse data transmission from the MS, setting a reverse data rate and a transmission duration negotiated with the MS, and connecting a reverse data channel to the MS;
periodically determining permission information for the MS, the permission information indicating whether reverse data transmission is permitted; and
transmitting the permission information to the MS on a forward access permission control channel.

10. The method of claim 9, wherein the reverse data channel connecting step comprises the steps of:
receiving from the MS in a dormant state an assignment request message including assignment information about the reverse data channel; and
transmitting to the MS an assignment message including information about the reverse data rate and the transmission duration in response to the assignment request message.

11. The method of claim 9, wherein the permission information is transmitted in each frame of the forward access permission control channel.

12. The method of claim 9, further comprising the steps of:
changing the data rate and the transmission duration according to an amount of transmission data received from the MS and a channel state of the MS, when the BS determines that the data rate and the transmission duration need to be changed; and
transmitting to the MS information about the determined data rate and the determined transmission duration.

13. The method of claim 9, further comprising the steps of:
receiving information about an amount of the transmission data from the MS after the reverse data channel is connected; and
updating information about the transmission data for the MS according to the received information.

14. The method of claim 9, further comprising the steps of:
receiving from the MS information about a channel state of the MS after the reverse data channel is connected; and
updating information about the channel state for the MS according to the received information.
